(19) United States
(12) Patent Application Publication
(10) Pub. No.: US 2013/0309088 A1
(43) Pub. Date: Nov. 21, 2013

(54) Method for Protecting Wind Turbine Equipment in Fire Event

(71) Applicant: Stephen Steen, Carpinteria, CA (US)

(72) Inventor: Stephen Steen, Carpinteria, CA (US)

(73) Assignee: Clipper Windpower, LLC, Carpinteria, CA (US)

(21) Appl. No.: 13/471,990

(22) Filed: May 15, 2012

(51) Int. Cl. F03D 7/04

(52) U.S. Cl. 416/1

(57) ABSTRACT

A method for protecting wind turbine equipment in a fire event is disclosed. The method may include providing a wind turbine and a fire detection and suppression system capable of detecting a fire within the wind turbine, the fire detection and suppression system further capable of generating and communicating a fire signal to the wind turbine, the fire signal including a location of the fire within the wind turbine and taking one or more actions by the wind turbine in response to the fire signal, the one or more actions dependent upon the location of the fire within the wind turbine.

### FIELD OF THE DISCLOSURE

The present disclosure relates generally to wind turbines and, more particularly, relates to protecting equipment within wind turbines during fire events.

### BACKGROUND OF THE DISCLOSURE

A utility-scale, horizontal axis wind turbine typically includes a set of two or three large rotor blades mounted to a hub. The rotor blades and the hub together are referred to as the rotor. The rotor blades aerodynamically interact with the wind and create lift, which is then translated into a driving torque by the hub. The rotor is attached to and drives a main shaft, which in turn is operatively connected via a drive train to one or more generators that produce electrical power. The main shaft, the drive train and the generator(s) are all situated within a nacelle, which is situated on top of a tower. The electrical power from the one or more generators is eventually routed through a transformer to boost voltage. The transformer may be located within the nacelle, in the tower, or outside of the tower on the ground. Various other electrical and other subsystems may also be found on a wind turbine.

Fires within a wind turbine can have several causes. For example, during a heavy thunderstorm, the wind turbine (e.g., the rotor blades) may be struck by lightning, which can ignite a fire. Fire may also be caused by failures in electrical installations such as overheating and arcing following earth fault/short circuits, or overloading. A variety of combustible materials may be found in a wind turbine such as mineral oil within a transformer, gearbox lubrication and hydraulic oil, grease, and fiber reinforced composite materials, which may all contribute to fires.

Fires can cause severe damage to the components of the wind turbine, resulting in significant remediation costs. In addition, fires may result in significant losses due to the interruption of operations of the wind turbine, and liability for collateral property damage. These potential losses increase in magnitude with the complexity and size of the wind turbine. With the ongoing increase in wind turbine complexity and size, there is increased interest by wind farm operators, financers, and insurers in employing fire detection and suppression systems.

Fire detection and suppression systems in use on wind turbines today are simply third party systems that are added to the wind turbine, without any level of integration in the operations of the wind turbine. Without any integration, in the event of a fire, the wind turbine (and control systems thereof) may not be able to take protective actions which could be taken to minimize damage to the wind turbine components and fight the spread of the fire.

### SUMMARY OF THE DISCLOSURE

In accordance with one aspect of the present disclosure, a method for protecting wind turbine equipment in a fire event is disclosed. The method may include providing a wind turbine and a fire detection and suppression system capable of detecting a fire within the wind turbine, the fire detection and suppression system further capable of generating and communicating a fire signal to the wind turbine, the fire signal including a location of the fire within the wind turbine and taking one or more actions by the wind turbine in response to the fire signal, the one or more actions dependent upon the location of the fire within the wind turbine.

In accordance with another aspect of the present disclosure, a method of operating a wind turbine is disclosed. The method may include detecting if a fire is present in one of several locations on the wind turbine and placing the wind turbine in one of several different protective positions depending upon the location of the detected fire.

In accordance with yet another aspect of the present disclosure, a method of operating a wind turbine is disclosed. The method may include detecting if a fire is present in one of several locations on the wind turbine and taking actions to perform a safe shut down of the wind turbine if a fire is detected, and then following a delay, commanding an emergency feather condition shut down of the wind turbine if the safe shut down of the wind turbine fails.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary block diagram showing a fire suppression system and integration of the fire suppression system within the wind turbine of FIG. 1;

FIG. 3 is a bird's eye view of the wind turbine of FIG. 1 illustrating one possible protective position for a rotor of the wind turbine to protect it from fires in certain locations; and

FIG. 4 is an elevational view of the wind turbine of FIG. 1 taken from the vantage point indicated in FIG. 3, which shows a protective azimuthal position of rotor blades to protect them from fires in certain locations.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

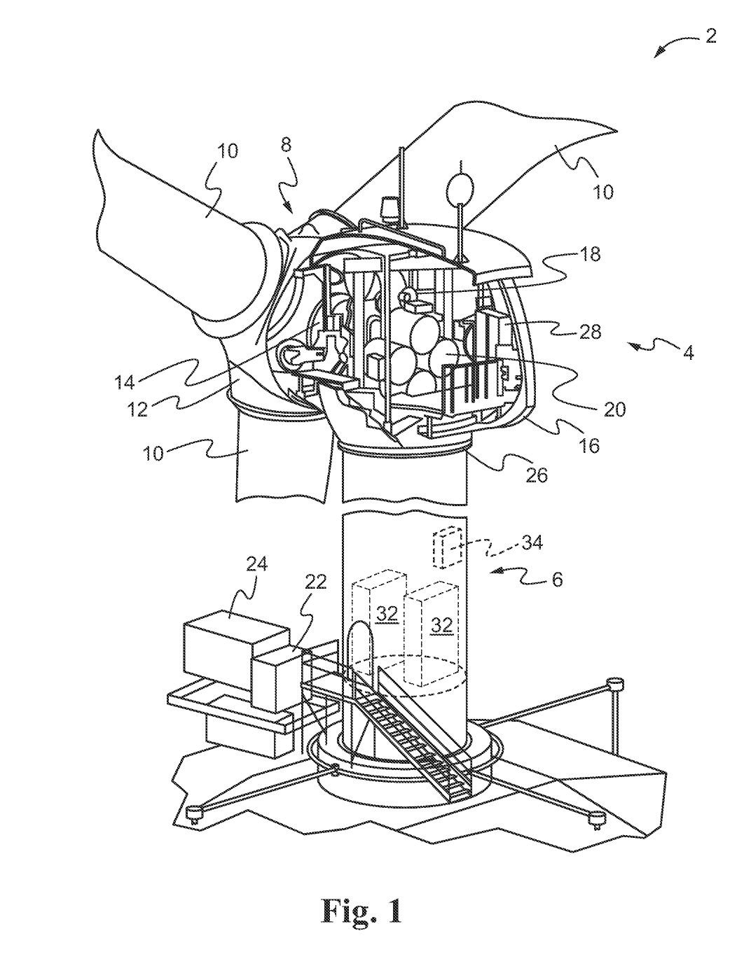

Referring to FIG. 1, an exemplary wind turbine 2 is shown, in accordance with at least some embodiments of the present disclosure. While all the components of the wind turbine have not been shown and/or described, a typical utility scale, horizontal axis wind turbine may include an up tower section 4 and a down tower section 6. The up tower section 4 may include a rotor 8 having a plurality of rotor blades 10 connected to a hub 12. The blades 10 may rotate with wind energy and the rotor 8 may transfer that energy to a main shaft 14 situated within a nacelle 16. The nacelle 16 may additionally include a drive train 18, which may connect the main shaft 14 on one end to one or more generators 20 on the other end. The generators 20 may generate electrical power, which may be transmitted from the up tower section 4 through the down tower section 6 and eventually to a power distribution panel (PDP) 22 and a pad mount transformer (PMT) 24 for transmission to a grid (not shown). The PDP 22 and the PMT 24 may be positioned outside (e.g., in the vicinity) of the wind turbine 2 as illustrated, but in many cases they may also be positioned inside of the down tower section 6, or inside of the nacelle 16. The positions and arrangements of the basic components in FIG. 1 are exemplary only, other positions and arrangements are possible and used.

In addition to the components of the wind turbine 2 described above, the up tower section 4 of the wind turbine may include several other sub-systems and auxiliary components, such as, a yaw system 26 on which the nacelle 16 may be positioned to pivot and orient the rotor 8 in a direction facing the wind, a pitch control system (not visible) situated within the hub 12 for controlling the pitch (e.g., angle of attack of the blades with respect to the air flowing over them) of the blades 10, a hydraulic power system (not visible) to provide hydraulic power to various components such as brakes of the wind turbine, a cooling system (also not visible), and the like. A turbine control unit (TCU) 28 may be situated within the nacelle 16 for controlling the various components of the wind turbine 2. It will be understood by those of ordinary skill in this art that the wind turbine 2 may include other sub-systems and auxiliary components that are contemplated and considered within the scope of the present disclosure.

Among other components, the down tower section 6 may include generator control units (GCUs) 32 and a down tower junction box (DJB) 34. The GCUs 32 are converters for converting direct current (DC) electric power from the generators to alternating current (AC) electric power that is synchronized in frequency and voltage for output to the electrical grid. The electrical power output of the GCUs 32 is routed through the PDP 22 and the PMT 24. The PDP 22 and the DJB 34 also take power from the grid and route it to various sub-systems and components of the wind turbine 2. Within the PDP 22 is found a circuit breaker, commonly called CB1, which serves as the electrical connection point between all of the sub-systems of the wind turbine 2 and their supply of electrical power from the grid, and likewise serves as the connection point between the electrical power output of the GCUs 32 and the electrical grid. When CB1 is opened, virtually everything on the turbine 2 is disconnected from the electrical grid.

The wind turbine 2 may also include a known safety feature called a safety loop. The safety loop interconnects with all the major sub-systems of the wind turbine 2, such as the GCUs 32, the PDP 22, the TCU 28, the pitch system in the hub 12, and others. The safety loop includes a circuit which loops through each of the interconnected sub-systems, and each sub-system has a switch, which in the closed position completes the circuit, and in the open position opens the circuit. The safety loop functions to provide an “all-clear” signal from each of the interconnected systems to all the other systems. During normal operation, each switch at each sub-system will be closed and a voltage signal will be present throughout the circuit. Instead of an electrical signal, a photo signal can also be used with fiber optic cables instead of wires. If any of the sub-systems detects a serious fault, then it opens its switch, which in turn opens the circuit, resulting in removing the signal at every other component. The other components react to sensing the lack of the voltage signal in the safety loop by quickly shutting down all the functions of the wind turbine 2. When the safety loop is tripped by any sub-system of the wind turbine 2, the CB1, which is also directly interconnected with the safety loop, will independently open to remove all connections of the wind turbine to grid electric power.

Opening of the safety loop also causes an emergency feather condition (EFC) shut down of the wind turbine 2, a rapid transition from whatever operational state the wind turbine is in to a standby or shut down state. An EFC can be characterized as a partly uncontrolled shut down. Each of the sub-systems of the wind turbine 2 takes steps to de-energize and stop functioning itself, mostly without any coordination with the other sub-systems. For example, the pitch control system during an EFC will move each of the rotor blades 10 from any current pitch angle position to a feathered pitch angle position as rapidly as possible, regardless of the speed of the forces exerted on the rotor because of this action. The uncontrolled nature of an EFC often means that an EFC shut down exerts large loads not only on the rotor 8, but also on the down tower section 6, bearings and other components. Over time, the accumulation of EFC shut downs can degrade the health of the wind turbine 2 and shorten its lifespan through fatigue and other wear. As a consequence, it is normally a goal to operate the wind turbine 2 in such a manner as to avoid EFC shut downs.

The wind turbine 2 can also be shut down in a controlled fashion, by coordinating the pitch activity of the rotor blades 10 with the rotor 8 and the wind speed, and slowly slowing the rotor to minimize forces. Likewise, the electrical systems of the wind turbine 2 can shut down in a fashion more controlled than during an EFC which can reduce transient spikes in voltage or current that can degrade certain components. A normal shut down, in a controlled fashion, will take longer than an EFC shut down but is preferred because it does not risk damaging the wind turbine 2.

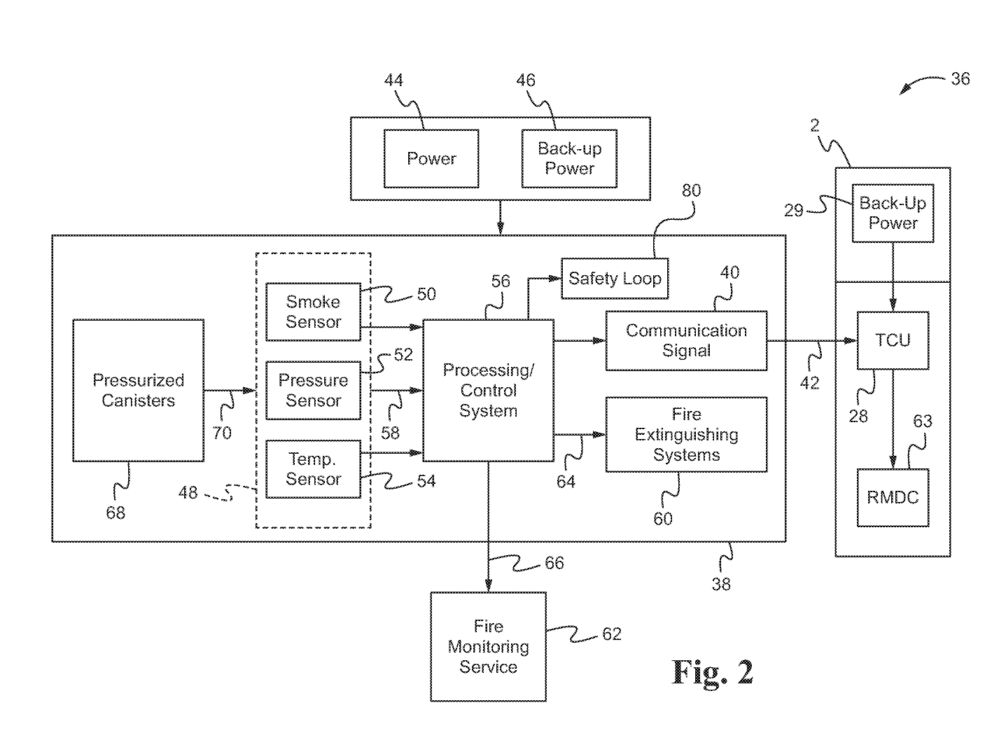

Referring now to FIG. 2, an exemplary block diagram of a fire system 36 is shown, in accordance with at least some embodiments of the present disclosure. As shown, the fire system 36 may include a fire detection and suppression system 38 in communication with the wind turbine 2. Specifically, the fire detection and suppression system 38 may be in communication with the TCU 28 of the wind turbine 2 via a communication signal (also referred to herein as a fire signal or warning signal) 40 that may be transmitted from the fire detection and suppression system to the TCU via a communication link 42. The communication signal 40 may include information such as the location of the fire (or signs of imminent fire or other warning signs, thermal events and their locations) within the wind turbine 2. The communication link 42 is intended to be representative of a variety of communication/data transfer media that are commonly employed in wind turbine settings including, for example, wired or wireless links, digital buses, radio channels, or links involving the internet or the World Wide Web. Other types of communication links may also be employed.

With respect to the fire detection and suppression system 38, in at least some embodiments, it may include a plurality of fire detection systems, such as various sensors, some of which are explained below. In addition, the fire detection and suppression system 38 may also include a plurality of fire extinguishing agents or devices, as also explained below. In at least some embodiments, the fire detection and suppression system 38 may be located either within the up tower section 4 such as, within the hub 12 or the nacelle 16, or it may be located within the down tower section 6 as well. In other embodiments, the fire detection and suppression system 38 may be located outside of the wind turbine as well or in any other part of the wind turbine 2.

The fire detection and suppression system 38 may be a stand-alone system that operates independently. It does not require any inputs nor does it rely upon the functionality of any other sub-systems of the wind turbine 2, other than its own suite of fire detection sensors and suppression sub-systems. While the fire detection and suppression system 38 may generate and communicate the communication signal 40 to the TCU 28, it may not require a return signal or any other signal from the TCU 28 to function. The fire detection and suppression system 38 may be interconnected with the safety loop of the wind turbine 2 within a safety loop module 80. The safety loop module 80 may contain a switch which when open de-energizes the safety loop by opening its circuit, and removes the voltage signal which the other sub-systems utilize as an indication that all the other sub-systems are functioning properly. Upon the detection of a fire, the fire detection and suppression system 38 may open the switch within the safety loop module 80, as will be described in more detail below, in order to force an immediate EFC shut down of the wind turbine 2. Further, upon the detection of a fire, the fire detection and suppression system 38 may also independently notify a remote fire monitoring service 62, as will also be described in further detail below.

Power to operate the fire detection and suppression system 38 may be provided by an independent power system 44 and backed-up by a backup power system 46. The power system 44 and the backup power system 46 may be any of a variety of systems that are commonly employed in fire detection and suppression systems in general and in at least some embodiments, they may be dedicated specifically to the fire detection and suppression system 38. Furthermore, although the power and the backup power systems 44 and 46, respectively, have been shown as being dedicated components for the fire detection and suppression system 38 (e.g. the TCU 28 may draw back-up power from its own source 29), it will be understood that this need not always be the case. Rather, in at least some embodiments, one or both of the power system 44 and the backup power system 46 may serve to provide power and back-up power to other wind turbine 2 sub-systems. For example, the TCU 28 and the fire detection and suppression system 38 may be powered by the same power and back-up power system.

Providing the fire detection and suppression system 38 as an independent component within the wind turbine 28 may likely be the most cost effective method of integration. As a safety system, the fire detection and suppression system 38 will be required to have adequate physical protections and redundancies in order to ensure that it will very reliably operate as intended. If the fire detection and suppression system 38 depends upon a signal from TCU 28 to function, then the TCU 28 would be required to meet the very same standards concerning physical protection and redundancies and reliability, which would likely drive a lot of additional costs. Because the fire detection and suppression system 38 provides communication signal 40 to the TCU 28, several important benefits of integration can be achieved, but without the costs that would result from more fully integrating the fire detection and suppression system 38 into TCU 28.

Now, with respect to detecting fire (or imminent fire or a thermal event) within any component within the wind turbine 2, the fire detection and suppression system 38 may have a plurality of sensors 48. For example, as shown, the fire detection and suppression system 38 may have a smoke sensor 50 for detecting smoke and a temperature sensor 54 for measuring abnormal temperature variations within various mechanical and electrical components of the wind turbine. Notwithstanding the fact that only the smoke sensor 50 and the temperature sensor 54 have been described, several other sensors, such as, flame detectors, water detectors, heat detectors, etc., may be provided in addition or alternative to the above described sensors. Measurements taken by the sensors 48 may be provided to a central processing and control system 56 of the fire detection and suppression system 38 via one or more communication links 58. The fire detection and suppression system 38 may also include health or operational readiness sensors such as a pressure sensor 52 for detecting loss of or inadequate pressure in pressurized fluid canisters 68 (such as carbon dioxide canisters) that may form part of a fire extinguishing systems 60.

The central processing and control system 56 may be one or more computer systems (such as embedded or general purpose computer systems) that may be capable of receiving information from the sensors 48 and using programmed logic to undertake reactions to the sensor signals such as generating and communicating any fire (or imminent fire) signals to the wind turbine 2 via the communication signal 40 and the communication link 42, activating one or more of the fire extinguishing systems 60, and/or notifying the fire monitoring service 62. The processing and control system 56 may include a variety of volatile or non-volatile memory/storage devices, such as, flash memory, read only memory (ROM), programmable read only memory (PROM), erasable programmable read only memory (EPROM), electronically erasable programmable read only memory (EEPROM), etc., processing devices and computer readable media, such as, flash drives, optical disc drives, floppy discs, magnetic tapes, drums, cards, etc. Other types of computing, processing as well as reporting and storage devices may be present within (or used in conjunction with) the processing and control system 56. Furthermore, information from the sensors 48 (and other components communicating with the processing and control system) may be transmitted to the central processing and control system 56 either continuously or at set intervals of time, depending upon the type of trouble detected by those sensors (or components). The central processing and control system 56 and the power supply 44 and backup power supply 46 may ideally be located in its own cabinet inside of the nacelle 16 or the down tower section 6. They may be located in their own, separate cabinet so as to avoid a failure of any other component from affecting the fire detection and prevention system 38.

The fire extinguishing systems 60 may be activated by the central processing and control system 56 via a communication link 64. In at least some embodiments, the fire extinguishing systems 60 may include a variety of fire extinguishing agents that may be discharged or otherwise deployed upon instruction from the central processing and control system 56 for suppressing or retarding fires. The fire extinguishing agent may be any of a variety of types such as carbon dioxide gas, water, or powdered fire retardants deployed in a stream of compressed gas from a canister. The fire extinguishing systems 60 may be specifically designed and the agent may be chosen to match the type of fire to be extinguished. For example, a carbon dioxide or other gaseous retardant may be ideally suited for putting out a fire located within certain components, while a powdered retardant might be more appropriate for another different component. If the agent is a pressurized gas or held in a pressurized gas canister, the canisters 68 may be used with the previously described pressure sensors to monitor health and readiness.

The central processing and control system 56 may notify the fire monitoring service 62 via a communication link 66. The fire monitoring service 62 could be any type of remote monitoring service that receives the fire signal from the fire detection and suppression system 38 and deploys appropriate personnel and resources to respond to the fire. For example, the fire monitoring service 62 could be a manned call center that receives a generated voice message about the fire from the fire detection and suppression system 38. Similar to the communication link 42, the communication links 58, 64, 66 and 70 may be any of a variety of data transfer/communication media links including wired or wireless network interfaces, digital buses, radio channels or links involving the internet.

Referring still to FIG. 2, a more detailed description of several possible responses to detected fires will be described. One type of reaction would be for the fire detection and suppression system 38 to trip the safety loop switch inside the safety loop module 80 in each instance of a detected fire. As previously explained, this would result in all the sub-systems of the turbine immediately reacting by performing an EFC shut down of the wind turbine 2. However, this may not be the most appropriate response in many cases. One reason for this is the potential for false positives. The inclusion of the fire detection and suppression system 38 within wind turbine 2 may result in a large number of false positives being generated to indicate a fire has begun when in fact there is no fire. If each false positive results in an EFC shut down, over time the accumulation of these additional EFC shut downs may shorten the life span of some of the components of the wind turbine 2. In the case of certain detected fires, it may not be necessary to shut down the wind turbine 2 through an EFC shut down. It would be advantageous if the number of EFC shut downs could be minimized. Also, while an EFC shut down quickly de-energizes all the electrical circuits in the wind turbine 2 which can be advantageous in fighting the fire, this type of shut down does nothing more to mitigate any damage that might be caused as the fire continues to burn, and because power to yaw and pitch motors is turned off or limited, there remain very few options for reacting after an EFC.

TABLE 1

| Fire Location | Fire Detection System Actions | TCU Actions |
|---|---|---|
| Transformer | Send fire warning signal to fire monitoring | If MVSG is present and |
| | service | controllable, then command |
| | Send fire warning signal to TCU with | MVSG to open, turbine will then |
| | location | automatically EFC due to loss of |
| | After delay, trip safety loop. | grid connection |
| | | OR |
| | | Perform safe shut down (move |
| | | to standby in normal fashion, not |
| | | EFC) and simultaneously: |
| | | Yaw rotor 180 degrees from |
| | | transformer location, |
| | | Park rotor with azimuthal |
| | | position of blades at 2, 6, and 10 |
| | | o'clock positions, lock rotor, and |
| | | then |
| | | Trip CB1 to turn off all power |
| | | to turbine |
| Power | Send fire warning signal to fire monitoring | If MVSG is present and |
| Distribution | service | controllable, first perform safe |
| Panel (PDP) | Send fire warning signal to TCU w/ | shut down, then open MVSG |
| | location | OR |
| | After delay, trip safety loop | Perform safe shut down and |
| | | simultaneously: |
| | | Yaw rotor 180 degrees from |
| | | transformer location |
| | | Park rotor with azimuthal |
| | | position of blades at 2, 6, and 10 |
| | | o'clock positions, lock rotor, and |
| | | then |
| | | Trip CB1 to turn off all power |
| | | to turbine |
| GCU | Send fire warning signal to fire monitoring | Perform safe shut down, then |
| | service | Trip CB1 to turn off all power to |
| | Send fire warning signal to TCU w/ | turbine |
| | location | |
| | After delay, trip safety loop | |
| DJB | Send fire warning signal to fire monitoring | Perform safe shut down, then |
| | service | Trip CB1 to turn off all power to |
| | Send fire warning signal to TCU w/ | turbine |
| | location | |
| | After delay, trip safety loop | |
| TCU | Send fire warning signal to fire monitoring | Perform safe shut down, then |
| | service | Trip CB1 to turn off all power to |
| | Send fire warning signal to TCU w/ | turbine |
| | location | |
| | After delay, trip safety loop | |
| Gearbox/ | Send fire warning signal to fire monitoring | Perform safe shut down and |
| Nacelle | service | simultaneously . . . |
| | Send fire warning signal to TCU w/ | Yaw rotor to position upwind |
| | location | of nacelle if not already done, |
| | After delay, trip safety loop | Park rotor with azimuthal |
| | | position of blades at 2, 6, and 10 |
| | | o'clock positions, lock rotor, and |
| | | then |
| | | Trip CB1 to turn off all power |
| | | to turbine |
| Blade(s) | Send fire warning signal to fire monitoring | Perform safe shut down and |
| | service | simultaneously . . . |
| | Send fire warning signal to TCU w/ | Park rotor with azimuthal |
| | location | position of single burning blade |
| | After delay, trip safety loop | at 3 o'clock position and |
| | | downwind from the other blades, |
| | | lock rotor, |
| | | Yaw nacelle so that rotor |
| | | plane is parallel with the wind |
| | | direction, but make adjustment if |
| | | this results in burning blade |
| | | directly over transformer, and |
| | | then |
| | | Trip CB1 to turn off all power |
| | | to turbine |
| Hub | Send fire warning signal to fire monitoring | Perform EFC shut down (this |
| | service | will happen automatically when |
| | Send fire warning signal to TCU w/ | F.S.S. trips safety loop) |
| | location | |
| | Immediately trip safety loop | |

With the fire detection and suppression system 38 sending a communication signal 40 to the TCU 28 concerning the location of a detected fire, the separate and independent responses of the fire detection and suppression system 38 and the TCU 28 can be coordinated in a very beneficial fashion to resolve some of these shortcomings, as described in Table 1 above.

For example, a possible integrated response to a transformer fire is illustrated in row 1 of the Table 1 above. If the sensor suite of the fire detection and suppression system 38 detects a fire in the PMT 24, the fire detection and suppression system 38 may immediately send a signal to the remote fire monitoring service 62 and a communication signal 40 to the TCU 28 concerning the fire and the location of the fire. The fire detection and suppression system 38 may not immediately trip the safety loop switch inside of the safety loop module 80. Rather, the fire detection and suppression system 38 may allow the TCU 28 time to take certain preventative and protective actions to minimize the danger from the fire.

Two possible scenarios for action taken by the TCU 28 are given in Table 1 for a transformer fire. In some wind farm site installations, a medium voltage switch gear (MVSG) may be present to control the connection of the transformer (i.e., the PMT 24) to the medium voltage electric grid in the wind farm. The TCU 28 may be capable of directly or indirectly (perhaps through a Supervisory Control and Data Acquisition System (SCADA) or a power plant controller system) sending a signal to the MVSG to open. If this is possible, the best response is probably to open the MVSG as soon as possible to de-energize the PMT 24.

If opening the MVSG is not possible, then the TCU 28 may take the following actions. The TCU 28 can begin to command a safe shut down of the wind turbine 2, or in other words may move the wind turbine to its standby mode without the use of an EFC shut down. A safe shut down is more controlled and results in less wear and tear on the wind turbine 2. In a safe shut down, the rotor 8 may be allowed to decelerate more slowly, without the abrupt and turbulent deceleration and resulting stresses and strains caused by an EFC shut-down.

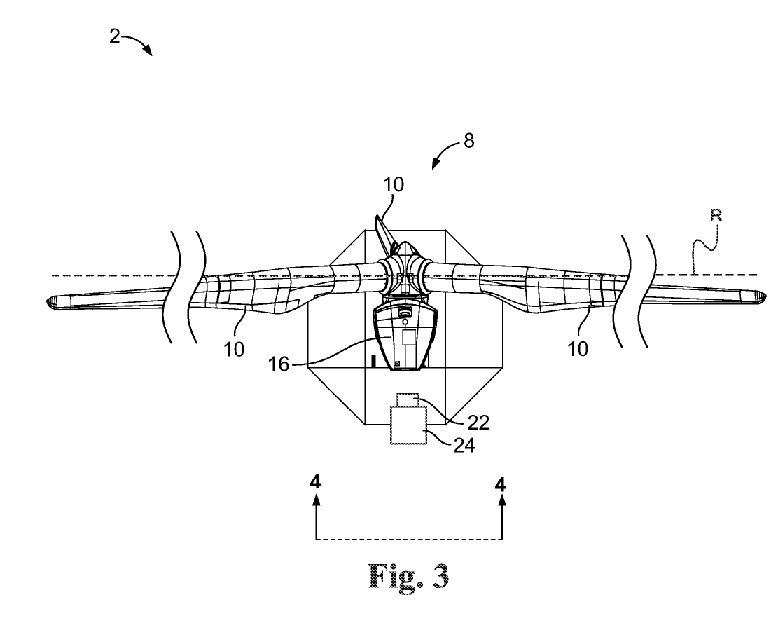

While shutting down, the TCU 28 may also take steps to put the wind turbine 2 in a protective position that may best protect the wind turbine from fire damage from a burning transformer (i.e., the PMT 24). If the transformer is outside the wind turbine 2, like the PMT 24 illustrated in FIG. 1, the rotor 8 may be yawed so that a rotor plane R (See FIG. 3) is one hundred eighty degrees (180 degrees) on the opposite side of the transformer relative to the tower (i.e., PMT 24), as illustrated in FIG. 3 which is a bird's eye view of the turbine. In general, such a position of the rotor 8 positions the rotor blades 10 as far as possible from the transformer (i.e., PMT 24).

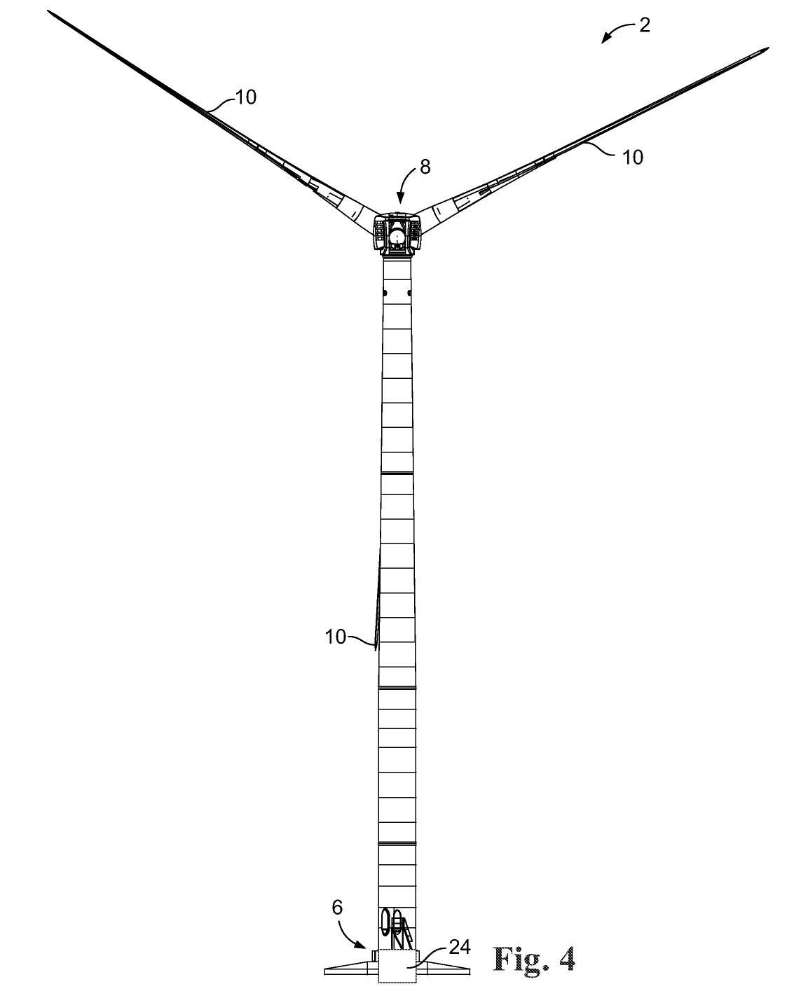

In addition, the wind turbine 2 may be capable of adjusting the azimuthal position of the rotor blades 10 and parking the rotor blades at a suitable azimuthal position. If this is possible, the TCU 28 may command the rotor 8 to rotate until the rotor blades 10 are located at two o'clock (2 o'clock), six o'clock (6 o'clock), and ten o'clock (10 o'clock) positions, as illustrated in FIG. 4, which is an elevational view of the wind turbine 2 taken along line 4-4 indicated in FIG. 3. In FIG. 4, two of the rotor blades 10 can be seen at the two o'clock (2 o'clock) and the ten o'clock (10 o'clock) positions, and it can further be observed that the blade at the six o'clock (6 o'clock) position is shielded from the transformer (i.e., PMT 24) by the down tower section 6. After the rotor blades 10 are put in this protected position, the rotor 8 may be parked so that the rotor can no longer rotate. In this shielded position behind the down tower section 6, the rotor blades 10 may be best protected from the burning transformer (i.e., PMT 24). Because the PMT 24 contains mineral oil for cooling purposes, a fire within the PMT can result in a very energetic explosion, so protection of the rotor blades 10 is warranted.

After these actions are taken by TCU 28, it may finally command CB1 to open to de-energize all electrical circuits inside the wind turbine 2 to further enhance safety.

The fire detection and suppression system 38 may allow the TCU 28 anywhere between approximately one to five minutes (1-5 minutes) to complete the above described actions. After this delay, the fire detection and suppression system 38 may trip the safety loop switch inside the safety loop module 80, which at that point may force an EFC shut down of the wind turbine 2 if for some reason the TCU 28 has not succeeded in shutting down the wind turbine already.

In row 2 of Table 1, the response to a fire detected in the PDP 22 is described. The fire detection and suppression system 38 may again first notify the remote fire monitoring service 62 and send the fire signal 40 with the location of the fire to the TCU 28, then it may wait a few minutes for the TCU to take certain actions.

The TCU 28 may take different actions depending upon whether an MVSG is present and controllable. If the MVSG is present and controllable, then the TCU 28 may first perform a safe shut down and then open the MVSG to de-energize all electrical circuits within wind turbine 2. If the MVSG is not present or controllable by the TCU 28, then the TCU may still perform a safe shut down. But so long as the power to the PDP 22 remains on because it cannot be shut off by an MVSG, the TCU 28 may as well take advantage of the power and place the rotor 8 in a protected position, the same position as was described above with respect to a fire in the PMT 24. After the rotor 8 is placed in a protected position, the TCU 28 may then open CB1 to cut off all power leaving from the PDP 22 to the wind turbine 2.

After the fire detection and suppression system 38 waits several minutes for these actions to be taken by TCU 28, it may then trip the safety loop switch inside the safety loop module 80, which at that point will force an EFC shut down of the wind turbine if for some reason the TCU has not succeeded in shutting down the turbine already.

Table 1 next describes actions to be taken in the event of fires detected in the GCUs 32, the DJB 34, or the TCU 28. In each case, the actions of the fire detection and suppression system 38 are the same as those already described above. The TCU 28 in these scenarios, upon receiving the fire signal 40 of a detected fire in these locations, will command a safe shut down of the wind turbine 2, and then will open CB1 to de-energize all the electrical circuits within the wind turbine.

Table 1 next describes actions to be taken in the event of a fire detected in the gearbox (i.e., the drive train 18) or the area of the nacelle 16 of the wind turbine 2. The fire detection and suppression system 38 may again immediately send a signal to the remote fire monitoring service 62 and to the TCU 28 concerning the detection of the fire and its location, then wait to give the TCU 28 time to act.

The TCU 28 in this case may command a safe shut down of the wind turbine 2, and simultaneously begin moving the rotor 8 to a protected position. In this case, the protected position is similar to the protected positions previously described, with the rotor blades 10 being moved to and parked at their two o'clock (2 o'clock), six o'clock (6 o'clock), and ten o'clock (10 o'clock) positions. The uppermost rotor blades 10 in this position, at the two o'clock (2 o'clock) and the ten o'clock (10 o'clock) positions, may not be exposed to flames that may be travelling upward from the nacelle 16. Also, the rotor 8 may be positioned so that it is directly upwind from the nacelle 16, so that any flames from the nacelle will be pushed away from the rotor blades 10.

After giving the TCU 28 several minutes to take these actions, the fire detection and suppression system 38 may at that point trip the safety loop switch in the safety loop module 80, and if the wind turbine 2 is not already in standby mode, it will be moved to that state by an EFC shut down.

Table 1 next describes the actions to be taken in case of a fire detected in one of the rotor blades 10. In this case, the fire detection and suppression system 38 will, as before, immediately send a signal to the remote fire monitoring service 62 and to the TCU 28 concerning the detection of the fire and its location, then wait to give the TCU 28 time to act.

The TCU 28 may immediately command a safe shut down of the wind turbine 2 to move the wind turbine to its standby state. Simultaneously, the TCU 28 may begin moving the rotor 8 into a protected position appropriate for a fire burning in or on a rotor blade. In this case, the rotor 8 may be rotated until the burning blade is in a three o'clock (3 o'clock) or a nine o'clock (9 o'clock) azimuthal position, and then the rotor may be parked or locked. If burning debris begins falling from the burning blade in this position, it will not land on the nacelle 16 or on another blade and spread the fire. Also, in this horizontal position the burning blade will be positioned away from the down tower section 6. The rotor 8 may be yawed so that the rotor is parallel to the wind direction and the burning blade in the three o'clock (3 o'clock) or the nine o'clock (9 o'clock) position is pointed downwind, so that flames emanating from it are most unlikely to reach the nacelle 16 or another blade. The wind direction may also help push the fire towards the end of the burning blade and impede the fire's advance back toward the hub 12.

After giving the TCU 28 several minutes to take these actions, the fire detection and suppression system 38 may at that point trip the safety loop switch in the safety loop module 80, and if the wind turbine 2 is not already in standby mode, it will be moved to that state by an EFC shut down.

Finally, Table 1 describes the actions to be taken in the case of a fire detected in the hub 12. The hub 12 may be a particularly dangerous place for a fire to break out. In the hub 12 is typically located the pitch system for controlling the pitch of the rotor blades 10. The pitch system may typically include some type of energy storage such as batteries, or hydraulic accumulators, or capacitors to provide emergency power to the pitch system to pitch the rotor blades 10 back towards feather in the case of an EFC to help ensure against a catastrophic overspeed event. If this energy storage is damaged by a fire, the rotor blades 10 may not be pitched back, and the rotor 8 may spin out of control until such a catastrophic overspeed event. Thus, in the case of a fire in the hub 12, time is of the essence and the best reaction is thought to be to immediately shut down via EFC. Therefore, in addition to informing the remote fire monitoring service 62 and sending the communication signal 40 to the TCU 28, the fire detection and suppression system 38 may immediately trip the safety loop switch inside the safety loop module 80. This will cause all the sub-systems of the wind turbine 2 to immediately shut down via EFC.

In all the above cases where the fire detection and suppression system 38 sends the communication signal 40 to the TCU 28, the TCU 28 may in addition to these other actions send a status to a remote monitoring and diagnostic center (RMDC) 63 that normally remotely monitors and controls the wind turbine 2, so that operators at the RMDC can be aware of the situation. But the notification to the RMDC 63 of the fire is not a critical step in addressing the fire, as the fire detection and suppression system 38 has already independently notified the remote fire monitoring service 62.

Table 1 is exemplary only of the types of customized reactions that the TCU 28 and the fire detection and suppression system 38 can take dependent upon the location of the fire. Different actions may be dictated or preferred depending upon the hardware configuration of the wind turbine 2 and the wind farm. The fire detection and suppression system 38 may work in coordination with the TCU 28 to take these actions to better protect the turbine in case of a fire, but the fire detection and suppression system 38 does not depend upon the TCU's actions because after at most a few minutes delay the fire detection and suppression system 38 will trip the safety loop in all cases and force an EFC if the turbine is not already in standby.

Accordingly, the present disclosure provides a fire system for a wind turbine. The fire system may include a fire detection and suppression system in communication with the wind turbine and, particularly, with the TCU (or some other component) of the wind turbine. As described above, the fire detection and suppression system may be a stand-alone system with its own central processor, separate power supply, various sensors directly connected thereto, etc. When the fire detection and suppression system determines that a fire (as referred to herein, the term “fire” may include any fire or thermal event) is occurring (or has occurred), it has its own communications capability to generate and send a signal to a fire monitoring service/station and give information about the fire. The fire detection and suppression system may also be directly connected to basic suppression or fire extinguishing equipment, such as, canisters of carbon di-oxide or other inert gases, water spray equipment, etc. to suppress and control small fires. The stand-alone fire detection and suppression system may deploy these suppression or extinguishing systems independently, without any input from the TCU (or other controlling component) of the wind turbine.

In addition to all of the above, the fire detection and suppression system may generate and send a communication signal (such as a warning or a trouble signal) to the TCU in the event of a fire, which in turn may notify the remote monitoring and diagnostics center (RMDC) of the trouble signal. Additionally, upon receiving the signal, certain activities may be undertaken by the TCU to help protect the wind turbine equipment. The options for protecting the wind turbine equipment and making the fire detection and suppression system more effective increase if the stand-alone fire system can send the TCU an indication of where the fire is located. With that information, the TCU can take very specific actions. The RMDC may also take its own precautionary actions and/or monitor the actions of the fire monitoring service and/or monitor the health of the wind turbine and the TCU.

Thus, the present disclosure provides a level of integration between the fire detection and suppression system and the wind turbine, where the fire detection and suppression system is capable of responding independently on its own without input from the wind turbine while also providing the wind turbine with information about the fire such that wind turbine can facilitate its own precautionary measures. By maintaining a separate fire detection and suppression system, the existing turbine components may not be required to meet the stringent standards applicable for fire protection and suppression systems, while still facilitating integration within the wind turbine. Furthermore, by increasing the coordination of the fire protection and suppression system with the wind turbine, losses due to fire may be prevented or at least reduced.

While only certain embodiments have been set forth, alternatives and modifications will be apparent from the above description to those skilled in the art. These and other alternatives are considered equivalents and within the spirit and scope of this disclosure and the appended claims.

We claim:

1. A method for protecting wind turbine equipment in a fire event, the method comprising:
providing a wind turbine and a fire detection and suppression system capable of detecting a fire within the wind turbine, the fire detection and suppression system further capable of generating and communicating a fire signal to the wind turbine, the fire signal including a location of the fire within the wind turbine; and
taking one or more actions by the wind turbine in response to the fire signal, the one or more actions dependent upon the location of the fire within the wind turbine.

2. The method of claim 1, wherein if the fire signal indicates fire within at least one of a transformer and a power distribution panel of the wind turbine, taking one or more actions by the wind turbine comprises immediately tripping a medium voltage switch gear positioned between an electric transmission grid and the transformer.

3. The method of claim 1, wherein if the fire signal indicates fire within at least one of the transformer and the power distribution panel of the wind turbine taking one or more actions comprises performing at least one of following actions: yawing a rotor of the wind turbine until a rotor plane of the rotor is positioned approximately one hundred and eighty degrees away from the fire location; and optimizing an azimuthal position of one or more blades of the wind turbine to space the blades away from the fire.

4. The method of claim 3, wherein the optimized azimuthal position of the one or more blades includes positioning a first blade at a substantially two o'clock position, a second blade at a substantially six o'clock position and a third blade at a substantially ten o'clock position.

5. The method of claim 1, wherein if the fire signal indicates fire within a gearbox or a nacelle of the wind turbine, taking one or more actions by the wind turbine comprises at least one of: yawing a rotor of the wind turbine to be positioned directly upwind of the nacelle and optimizing an azimuthal position of one or more rotor blades of the wind turbine.

6. The method of claim 5, wherein optimizing the azimuthal position of the one or more blades comprises positioning a first blade at a substantially two o'clock position, a second blade at a substantially six o'clock position and a third blade at a substantially ten o'clock position.

7. The method of claim 1, wherein if the fire signal indicates fire within one or more blades of the wind turbine, taking one or more actions by the wind turbine comprises yawing a rotor of the wind turbine so that a rotor plane of the rotor is parallel with the wind direction and optimizing an azimuthal position of the one or more blades of the wind turbine.

8. The method of claim 7, wherein the optimized azimuthal position of the one or more blades comprises positioning the burning blade at a substantially three o'clock position or a substantially nine o'clock position, and downwind from the other blades.

9. The method of claim 7, wherein a burning one of the blades is positioned so that it is not directly above a transformer of the wind turbine.

10. The method of claim 1, wherein if the location of fire is a hub of the wind turbine, the fire detection and suppression system trips a safety loop of the wind turbine by opening a switch in the safety loop to remove a signal throughout the safety loop.

11. The method of claim 10, wherein an emergency feather condition shut down of the wind turbine is facilitated by opening the switch of the safety loop.

12. The method of claim 1, wherein if the fire signal indicates fire within at least one of a generator control unit, a down tower junction box and a turbine control unit of the wind turbine, taking one or more actions by the wind turbine comprises safely shutting down the wind turbine and opening a circuit breaker to de-energize all electrical circuits within the wind turbine.

13. A method of operating a wind turbine, the method comprising:
detecting if a fire is present in one of several locations on the wind turbine; and
placing the wind turbine in one of several different protective positions depending upon the location of the detected fire.

14. The method of claim 13, wherein detecting fire comprises providing a fire detection and suppression system in communication with the wind turbine, the fire detection and suppression system having a plurality of sensors for detecting the fire.

15. The method of claim 14, wherein placing the wind turbine in the protective positions comprises receiving a fire signal from the fire detection and suppression system.

16. The method of claim 13, further comprising notifying a fire monitoring service of the detected fire.

17. A method of operating a wind turbine, the method comprising:
detecting if a fire is present in one of several locations on the wind turbine; and
taking actions to perform a safe shut down of the wind turbine if a fire is detected, and then following a delay, commanding an emergency feather condition shut down of the wind turbine in case the safe shut down of the wind turbine does not result in a complete shut down.

18. The method of claim 17, wherein the emergency feather condition shut down of the wind turbine comprises opening a switch of a safety loop system of a wind turbine to de-energize all electrical circuits of the wind turbine.

19. The method of claim 17, wherein taking actions further comprises positioning the wind turbine in a protective state depending upon the location of the detected fire.

20. The method of claim 19, wherein the protective state of the wind turbine comprises optimizing an azimuthal position of one or more blades of the wind turbine.
